(19) United States
(12) Patent Application Publication
(10) Pub. No.: US 2026/0058470 A1
(43) Pub. Date: Feb. 26, 2026

(54) GRID-FORMING ENERGY STORAGE SYSTEM AND CONTROL METHOD THERFOR

(71) Applicant: BEIJING STATE GRID ELECTRIC POWER TECHNOLOGY CO., LTD., Beijing (CN)

(72) Inventors: Ziguan Zhou, Beijing (CN); Xuming Li, Beijing (CN); Yaping Zhu, Beijing (CN); Qin Wang, Beijing (CN); Yiping Xu, Beijing (CN)

(21) Appl. No.: 19/310,838

(22) Filed: Aug. 26, 2025

Related U.S. Application Data
(63) Continuation of application No. PCT/CN2025/110464, filed on Jul. 24, 2025.

(30) Foreign Application Priority Data
Aug. 20, 2024 (CN) 202411141833.X

(51) Int. Cl. H02J 3/28; H02J 3/00; H02J 3/46; H02J 13/00

(52) U.S. Cl. CPC H02J 3/28; H02J 3/003; H02J 3/466; H02J 13/00002; H02J 13/00028; H02J 2203/20

(57) ABSTRACT

A grid-forming energy storage system includes a data interface and transfer module, a state analysis and prediction module, an event response and strategy adjustment module, and an energy scheduling and management module. In the present disclosure, the energy management efficiency in the smart grid is significantly improved through real-time data formatting and efficient information transfer, real-time transmission and accuracy of data are ensured by using a JSON formatted data interface and a TCP/IP protocol, the data processing flow is optimized in conjunction with Apache Kafka, and the throughput capacity is improved and the response time is shortened, such that the grid manages resources more efficiently. Through state analysis and demand prediction by Spark Streaming, the grid responds in real time and predicts energy demand changes to reduce the energy waste.

### TECHNICAL FIELD

The present disclosure relates to the technical field of smart grids, and in particular to a grid-forming energy storage system and a control method therefor.

### BACKGROUND

The technical field of smart grids focuses on integrating digital communication and information technology into power networks to enhance the management efficiency and reliability of the grid. In this technical field, the grid automatically monitors the flow of energy sources and the state of the power system to adjust and optimize supply and consumption of energy sources in real time. A smart grid supports integration of more renewable energy such as wind energy and solar energy, such that dependence on fossil fuels is reduced. The smart grid further improves the economic benefits and environmental sustainability of the grid, ensures better power quality and power distribution reliability, and enhances the capability of the grid to respond to failures. By introducing advanced metering facilities, demand response technology, and automatic management technology, the smart grid aims to achieve a more interactive, automatic, and efficient power system.

The grid-forming energy storage system is a highly modularized and automatized power system designed to optimize power storage and distribution. This system responds to the power demand changes quickly by exchanging state and demand information in real time among a plurality of storage units, thereby effectively optimizing the energy configuration and improving the overall efficiency of the system. This system is particularly suitable for environments requiring high energy management flexibility. For example, a smart grid having a function of generating electricity by renewable energy is mainly used to improve the utilization efficiency of energy sources, ensure the stable operation of the grid, and accelerate integration of the renewable energy sources, so as to support a sustainable energy development strategy.

A grid-forming energy storage system in the prior art improves the interactivity and automation level of the power system but still has limitations in terms of processing real-time batched data and distributing energy sources efficiently. Data processing in the grid-forming energy storage system in the prior art depends on a conventional batch processing method, which results in a delay in data processing, thereby making it hard to achieve real-time energy management and scheduling. The prior art also shows deficiencies in terms of event response mechanism. Particularly with a grid fault or a sharp increase in demand, the response speed and resource allocation efficiency of the existing system are still insufficient to cope with challenges in a peak period. The technical restriction not only increases the energy waste, but also affects the stability of the grid and the reliability of power supply. In the smart grid technology, although the renewable energy sources are additionally integrated, under highly variable energy input conditions and complex grid environments, existing scheduling and monitoring systems encounter difficulties in accurately predicting and managing dynamic changes, which affects the efficiency and economic benefit of the entire grid.

### SUMMARY

To overcome deficiencies in the prior art, an objective of the present disclosure is to provide a grid-forming energy storage system and a control method therefor.

In order to achieve the above objective, the present disclosure adopts the following technical solutions: a grid-forming energy storage system includes:
a data interface and transfer module, configured to perform JSON formatting on key parameters of an energy storage unit such as a voltage, a current, a temperature, and a remaining capacity according to data of the energy storage unit, where the data is transmitted to a central control configuration through a TCP/IP protocol to obtain an encoded data stream, and the encoded data stream is inputted to an Apache Kafka message queue to acquire a queue data stream;
a state analysis and prediction module, configured to input the queue data stream to a real-time data processing engine based on Spark Streaming to analyze data of the voltage, the current, the temperature, and the capacity, so as to obtain an analysis result of state time series, and dynamically estimate an energy demand of each unit to acquire a demand prediction result according to the analysis result of state time series;
an event response and strategy adjustment module, configured to identify an energy demand peak and an emergent bulk power consumption event according to the demand prediction result, match an event pattern, execute event processing by using an Esper engine to obtain an event response strategy, and adjust energy supply by means of the event response decision to acquire an optimized energy distribution plan; and
and an energy scheduling and management module, configured to receive the optimized energy distribution plan, adjust a charge-discharge strategy according to demand, record an energy flow condition, and analyze a charge-discharge efficiency of energy storage and adaptability to obtain a charge-discharge scheduling data result of energy storage of the smart grid.

As a further solution of the present disclosure, the step of acquiring the queue data stream specifically includes:
converting each key parameter value of the energy storage unit into an attribute of a JSON object through a formatting function according to the data of the energy storage unit, generating a formatted data packet by using the following formula:

$$Ja = {\sum }_{k ∈ K} f ( {p}_{k} ) \times {w}_{k} \div N$$

in the formula, K denotes the key parameter, pₖ denotes a real-time numerical value of a parameter k, f denotes a data formatting function, wₖ denotes a weight of the parameter k, N denotes the total number of parameters, and Ja denotes the formatted data packet;
by means of a transmitting function, transmitting the formatted data packet through the TCP/IP protocol, generating an encoded data stream by using the following formula:

$$Ea = \frac{1}{\sqrt{n}} {{\sum }_{i = 1}}^{n} s ( {Ja}_{i} )$$

in the formula, Jaᵢ denotes an i^{th} formatted data packet, n denotes the quantity of the data packets, s denotes the transmitting function, and Ea denotes the encoded data stream; and
inputting the encoded data stream to the Apache Kafka message queue, and by means of a queue function, generating a queue data stream by using the following formula:

$$Qa = q ( Ea ) \times ( 1 + \frac{1}{L} )$$

in the formula, Ea denotes the encoded data stream, q denotes the queue function, L denotes a load factor, and Qa denotes the queue data stream.

As a further solution of the present disclosure, the step of acquiring the analysis result of state time series specifically includes:
performing real-time processing on the queue data stream through a Spark Streaming engine, adjusting a processing speed and responsiveness of the data stream by applying a transfer function and combining an adjustment parameter, and generating a processed data stream by using the following formula:

$$St = g ( Qa ) \cdot ( α + \frac{{α}_{0}}{1 + {e}^{- k \cdot len ( Qa )}} )$$

in the formula, α is a baseline adjustment factor, α₀ and k are dynamic adjustment parameters, len(Qa) is configured to calculate a queue length, St denotes the processed data stream, Qa denotes an inputted queue data stream, and g is a real-time processed transfer function;
extracting key electrical features from the processed data stream, including the voltage, current, temperature, and capacity, and performing weighting in conjunction with a feature weight, and
generating a data stream feature set by using the following formula:

$$Ft = \frac{1}{Z} ( {\sum }_{k ∈ \{ V , I , T , C \}} h ( k , St ) \cdot {β}_{k} )$$

in the formula, h is a feature extraction function, βₖ is the feature weight, Z is a normalization constant, Ft denotes the data stream feature set, and V, I, T, C are respectively the voltage, the current, the temperature, and the capacity; and performing time sequence analysis on the data stream feature set, by means of an analytic function in conjunction with a time factor, and
generating an analysis result of state time series by using the following formula:

$$At = m ( Ft ) \cdot {( \frac{t}{τ + t} )}^{δ}$$

in the formula, t denotes a time variable, τ is a decay constant, δ is a time-dependent intensity factor, At denotes the analysis result of state time series, Ft denotes the data stream feature set, and m denotes the time series analytic function.

As a further solution of the present disclosure, the step of acquiring the demand prediction result specifically includes:
integrating energy data of each unit in the analysis result of state time series, combining historical data with current data by means of an enhanced integration function, and generating integrated data by using the following formula:

$$Bo = f ( At ) \times {( {{\sum }_{i = 1}}^{n} \frac{{D}_{i}}{\sqrt{n}} )}^{2}$$

in the formula, Dᵢ denotes a historical energy demand of the i^{th} unit, n denotes the total number of the units, At denotes the analysis result of state time series, f denotes the enhanced integration function, and Bo denotes the integrated data;
applying a prediction model to the integrated data to dynamically calculate a demand in a future time period, and generating a predicted energy demand by using the following formula:

$$Po = p ( Bo ) \cdot {( \frac{t}{τ + t} )}^{1 / τ}$$

in the formula, τ is a time delay constant, t is a time interval from a time when data is integrated to a predicted time, Po denotes the predicted energy demand, Bo denotes the integrated data, and p denotes the demand prediction model; and
outputting the predicted energy demand in a formatted manner, matching the predicted energy demand to an energy unit management configuration, and generating a demand prediction result by using the following formula:

$$Do = format ( Po ) \times {σ}^{2}$$

in the formula, format is a formatting function, σ is a formatting parameter, Do denotes a demand prediction result, and Po denotes the predicted energy demand.

As a further solution of the present disclosure, acquiring the event response decision specifically includes:
defining the energy demand peak and identifying the emergent bulk power consumption event by using the demand prediction result, and by applying a threshold identification method, generating an event pattern by using the following formula:

$$Eq = \{ x ∈ Do \vert x > θ \cdot ( 1 + \frac{1}{log ( e + n )} ) \}$$

in the formula, θ is a dynamically adjusted demand peak threshold, n denotes the quantity of data points in a time sequence, Eq denotes the event pattern, Do denotes the demand prediction result, and x denotes energy demand data of a single data point;
applying the event pattern to the Esper engine for pattern matching to identify a key energy event, and generating a matched event by using the following formula:

$$Mq = match ( Eq ) \times ( \frac{{\sum }_{i = 1}^{n} {ω}_{i}}{Ω} )$$

in the formula, ωᵢ is an importance weight of each event, Ω is the sum of the event weights, Mq denotes the matched event, Eq denotes the event pattern, and match denotes a pattern match function of the Esper engine; and
executing a decision logic and responding to the identified event according to the matched event to generate an event response decision by using the following formula:

$${W}_{q} = decision ( Mq ) \times ( \frac{1}{1 + {e}^{- k \cdot m}} )$$

in the formula, k is the adjustment coefficient, m denotes the quantity of the matched events, Wq denotes the event response decision, Mq denotes the matched event, and decision denotes a decision function applied to the matched event.

As a further solution of the present disclosure, the step of acquiring the optimized energy distribution plan specifically includes:
extracting data from the event response decision, analyzing and identifying the energy supply strategy needed to be adjusted, and generating analyzed energy data by using the following formula:

$$Ar = ( {{\sum }_{i = 1}}^{n} {Wq}_{i} \cdot {α}_{i} ) \div {n}^{1.5}$$

in the formula, Wqᵢ denotes data of the i^{th} event response decision, αᵢ denotes the adjustment coefficient, and Ar denotes the analyzed energy data;
adjusting the energy supply strategy according to the analyzed energy data, and matching the current energy demand with the predicted energy demand, and generating adjusted supply data by using the following formula:

$$Vr = m ( Ar ) \cdot sin ( \frac{π \cdot Ar}{max ( Ar )} )$$

in the formula, m is a function that adjusts the energy supply, Vr denotes the adjusted supply data, max(Ar) denotes the maximum value in the analyzed data, and Ar denotes the analyzed energy data; and
converting the adjusted supply data into an operation strategy, and forming the optimized energy distribution plan by using the following formula:

$$Hr = strategize ( Vr ) \cdot ( 1 + \frac{log ( 1 + Vr )}{log ( 2 )} )$$

in the formula, strategize is a function that adjusts and converts the supply into a strategy, Hr denotes the optimized energy distribution plan, Vr denotes the adjusted supply data, log(1+Vr) denotes a logarithmic transformation of small value adjustment, and log(2) denotes a base of logarithm.

As a further solution of the present disclosure, the step of acquiring the charge-discharge scheduling data result of energy storage of the smart grid specifically includes:
receiving the optimized energy distribution plan, and forming a summarized data view in conjunction with real-time energy consumption data by using the following formula:

$$Iu = \frac{{\sum }_{i = 1}^{n} ( {Hr}_{i} \times {C}_{i} )}{\sqrt{n}}$$

in the formula, Iu denotes the summarized data, Hrᵢ denotes the i^{th} strategy result data point, Cᵢ is corresponding energy consumption data, and n is the quantity of the data points;
monitoring energy flow by means of the summarized data view, and matching the supply with the demand, adjusting energy charge and discharge, and generating an energy flow state by using the following formula:

$$Fu = {( {\sum }_{i = 1}^{n} {Iu}_{i} \times {λ}_{i} )}^{\frac{1}{v}}$$

in the formula, λᵢ is a weight factor of each data point, v is a global parameter that adjusts a nonlinear response, Fu denotes the energy flow state, and Iu denotes the summarized data; and
analyzing an efficiency and adaptability of energy distribution according to the energy flow state, and generating the charge-discharge scheduling data result of energy storage of the smart grid by using the following formula:

$$Eu = ( \frac{{\sum }_{i = 1}^{n} F {u}_{i}}{{μ}_{i}} ) \cdot κ$$

in the formula, μᵢ is an efficiency benchmark of each state, κ is a coefficient for adaptive analysis, Eu denotes the charge-discharge scheduling data result of energy storage of the smart grid, and Fu denotes the energy flow state.

A grid-forming energy storage control method is executed through the grid-forming energy storage system, including the following steps:
S1: collecting the data of voltage, current, temperature, and remaining capacity of the energy storage unit through a control interface, formatting the data into JSON and controlling a data transmission process through the TCP/IP protocol, and optimizing a size and a transmission frequency of a data packet and matching a network condition to generate an encoded data stream;
S2: transmitting the data to Apache Kafka for control processing by means of the encoded data stream, and optimizing reliability of message processing by controlling sequencing and error detection of the data stream in the message queue to obtain a queue data stream;
S3: performing data control analysis on the queue data stream in a Spark Streaming environment, continuously monitoring the voltage, current, temperature, and capacity, analyzing a time sequence variation of parameters, and controlling and identifying an abnormal pattern to generate the analysis result of state time series;
S4: controlling a calculation of demand prediction according to the analysis result of state time series, defining and identifying the energy peak value and the emergent bulk power consumption event, controlling real-time response processing of the event, and adjusting an output configuration of the energy storage unit to acquire an event response decision; and
S5: controlling energy supply and output of energy storage by using the event response decision, adjusting the charge-discharge strategy according to a demand, controlling an energy flow and consumption condition of a network, and analyzing and adjusting the energy distribution strategy and optimizing energy storage control configuration performance to establish the charge-discharge scheduling data result of energy storage of the smart grid.

Compared with the prior art, the present disclosure has the following advantages and positive effects:

In the present disclosure, through real-time data formatting and efficient information transfer, the energy management efficiency in the smart grid is significantly improved; by using the JSON formatted data interface plus the TCP/IP protocol, real-time transmission and accuracy of data are ensured; the data processing flow is optimized taking Apache Kafka as the central message queue system, such that the throughput capacity of processing is improved and the response time of the system is shortened, and therefore, the grid can more efficiently manage and allocate resources. Through state analysis and demand prediction performed by Spark Streaming, the grid not only responds in real time, but also predicts the future energy demand change, which is beneficial to adjusting the resource configuration in advance, thereby reducing the energy waste. The event response processing of the Esper engine further enhances the adaptability of the system to the emergent events, such that when facing the demand peak or bulk power consumption event, the grid rapidly and effectively adjusts the energy supply, thereby improving the reliability and economical benefit of the grid.

### BRIEF DESCRIPTION OF THE DRAWINGS

FIG. 1 is a flow chart of a system of the present disclosure.

FIG. 2 is a flow chart of a queue data stream in the present disclosure.

FIG. 3 is a flow chart of an analysis result of state time series in the present disclosure.

FIG. 4 is a flow chart of a demand prediction result in the present disclosure.

FIG. 5 is a flow chart of an event response decision in the present disclosure.

FIG. 6 is a flow chart of an optimized energy distribution plan in the present disclosure.

FIG. 7 is a flow chart of a charge-discharge scheduling data result of energy storage of a smart grid in the present disclosure.

### DETAILED DESCRIPTIONS OF THE EMBODIMENTS

In order to make objectives, technical solutions, and advantages of the present disclosure clearer, the present disclosure will be further described in detail below in conjunction with drawings and embodiments. It should be understood that the specific embodiments described herein are merely used to explain the present disclosure, rather than limiting the present disclosure.

In the description of the present disclosure, it should be noted that an orientation relationship or a position relationship indicated by the terms “length”, “width”, “upper”, lower”, “front”, “back”, “left”, “right”, “vertical”, “horizontal”, “top”, “bottom”, “inside”, “outside”, and the like is an orientation relationship or a position relationship based on the drawing and is merely for ease of describing present disclosure and simplifying the description, rather than indicating or implying that a specified apparatus or element necessarily has a specific orientation or is constructed and operated in a specific orientation. Therefore, the terms should not be construed as a limitation on the present disclosure. In the description of the present disclosure, unless otherwise specified, “a plurality of” means two or more than two.

### Embodiment I

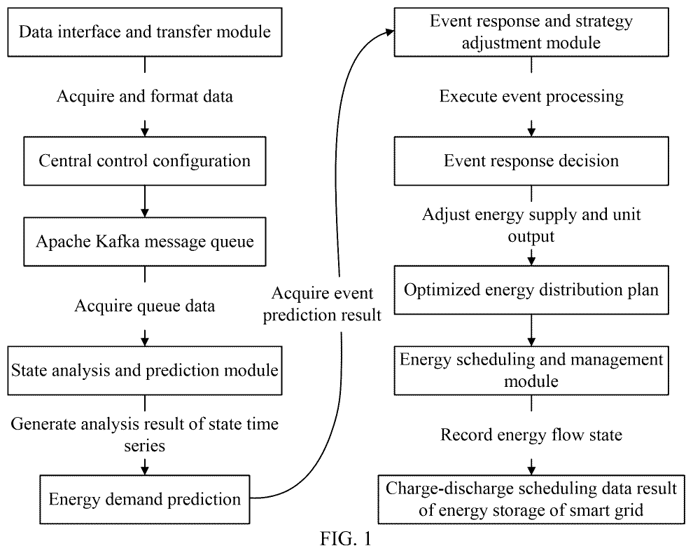

Referring to FIG. 1, the present disclosure provides a technical solution: a grid-forming energy storage system includes:
a data interface and transfer module, configured to perform JSON formatting on key parameters of a voltage, a current, a temperature, and a remaining capacity of an energy storage unit according to data of the energy storage unit, where the data is transmitted to a central control configuration through a TCP/IP protocol to obtain an encoded data stream, and the encoded data stream is inputted to an Apache Kafka message queue to acquire a queue data stream;
a state analysis and prediction module, configured to input the queue data stream to a real-time data processing engine based on Spark Streaming to analyze data of the voltage, the current, the temperature, and the capacity, so as to obtain an analysis result of state time series, and dynamically estimate an energy demand of each unit according to the analysis result of state time series to acquire a demand prediction result;
an event response and strategy adjustment module, configured to identify an energy demand peak and an emergent bulk power consumption event according on the demand prediction result, match an event pattern, execute event processing by using an Esper engine to obtain an event response strategy, and adjust energy supply by means of the event response decision to acquire an optimized energy distribution plan; and
an energy scheduling and management module, configured to receive the optimized energy distribution plan, adjust a charge-discharge strategy according to demand, record an energy flow condition, and analyze a charge-discharge efficiency of energy storage and adaptability to obtain a charge-discharge scheduling data result of energy storage of the smart grid.

The encoded data stream includes data serialization, transmission optimization, and protocol compatibility. The queue data stream includes a message queue length, a cache strategy, and transmission stability. The analysis result of state time series includes voltage trend analysis, current pattern identification, and temperature anomaly detection. The demand prediction result includes consumption estimation, demand responsiveness, and prediction accuracy. The event response decision includes strategy formation speed, event trigger accuracy, and decision execution efficiency. The optimized energy distribution plan includes supply adjustment range, output balance, and system response speed. The charge-discharge scheduling data result of energy storage of the smart grid includes monitoring system efficiency, data report precision, and scheduling adaptability.

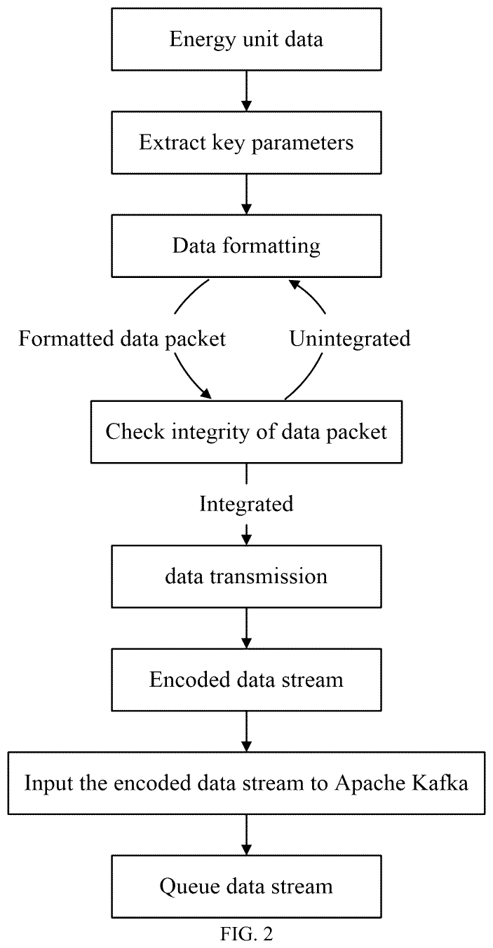

Referring to FIG. 2, the step of acquiring the queue data stream specifically includes:
converting each key parameter value of the energy storage unit into an attribute of a JSON object through a formatting function according to the data of the energy storage unit, generating a formatted data packet by using the following formula:

$$Ja = {\sum }_{k ∈ K} f ( {p}_{k} ) \times {w}_{k} \div N$$

in the formula, K denotes the key parameter, pₖ denotes a real-time numerical value of a parameter k, f denotes a data formatting function, wₖ denotes a weight of the parameter k, N denotes the total number of parameters, and Ja denotes the formatted data packet;
by means of a transmitting function, transmitting the formatted data packet through the PCP/IP protocol, generating an encoded data stream by using the following formula:

$$Ea = \frac{1}{\sqrt{n}} {\sum }_{i = 1}^{n} s ( {Ja}_{i} )$$

in the formula, Jaᵢ denotes an i^{th} formatted data packet, n denotes the quantity of the data packets, s denotes the transmitting function, and Ea denotes the encoded data stream; and
inputting the encoded data stream to the Apache Kafka message queue, and by means of a queue function, generating a queue data stream by using the following formula:

$$Qa = q ( Ea ) \times ( 1 + \frac{1}{L} )$$

in the formula, Ea denotes the encoded data stream, q denotes the queue function, L denotes a load factor, and Qa denotes the queue data stream. A formatted data packet formula:

$$Ja = {\sum }_{k ∈ K} f ( {p}_{k} ) \times {w}_{k} \div N$$

K: a set of all key parameters, for example, voltage (V), current (I), temperature (T), and remaining capacity (C));
pₖ: a real-time numerical value of each parameter, for example, V=3.7V, I=2.0 A, T=35° C., C=75%;
wₖ: a weight of each parameter, assuming that the weights are equal here, and each of the weights is 1;
N: the total number of the parameters, which is 4 here;
data preparation: V=3.7, 1=2.0, T=35, C=0.75, w_{V}=w_{I}=w_{T}=w_{C}=1, N=4;
Ja is calculated as follows:

$$Ja = \frac{( 3.7 \times 1 ) + ( 2.0 \times 1 ) + ( 35 \times 1 ) + ( 0.75 \times 1 )}{4} = \frac{41.45}{4} = 10 \text{.3625} .$$

This result (10.3625) denotes a parameter value after weighted averaging for further data processing.

An encoded data stream formula:

$$Ea = \frac{1}{\sqrt{n}} {\sum }_{i = 1}^{n} s ( J {a}_{i} ) .$$

Jaᵢ: a formatted data packet formula, which is 10.3625 in the above example;
n: the quantity of the data packets, assuming that 3 data packets exist;
It is assumed: Ja₁=Ja₂=Ja₃=10.3625, n=3;
Ea is calculated as follows:

$$Ea = \frac{1}{\sqrt{3}} {\sum }_{i = 1}^{3} 10.3625 = \frac{1}{1.732} \times 31.0875 = 17.943 .$$

Result explanation: this result (17.943) denotes a processed weighted data stream adapted to network transmission.

A queue data stream formula:

$$Qa = q ( Ea ) \times ( 1 + \frac{1}{L} ) .$$

Ea: an encoded data stream, which is 17.943 in the above example;
L: a system load factor, assuming that it is 5;
it is assumed: Ea=17.943, L=5;
Qa is calculated as follows:

$$Qa = 17.943 \times ( 1 + \frac{1}{5} ) = 17.943 \times 1.2 = 21.532 .$$

This result (21.532) denotes a processed data stream inputted to Apache Kafka for subsequent message queue processing.

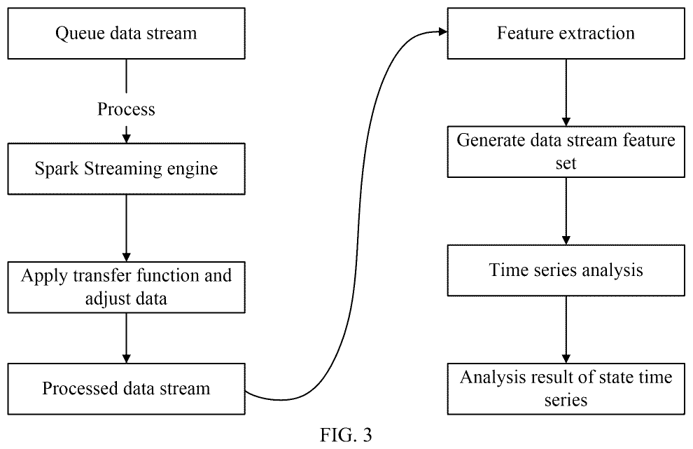

Referring to FIG. 3, the step of acquiring the analysis result of state time series specifically includes:
performing real-time processing on the queue data stream through a Spark Streaming engine, adjusting a processing speed and responsiveness of the data stream by applying a transfer function and combining an adjustment parameter, and
generating a processed data stream by using the following formula:

$$S t = g ( Qa ) \cdot ( α + \frac{{α}_{0}}{1 + {e}^{- k \cdot len ( Qa )}} )$$

in the formula, α is a baseline adjustment factor, α₀ and k are dynamic adjustment parameters, len(Qa) is configured to calculate a queue length, St denotes the processed data stream, Qa denotes an inputted queue data stream, and g is a real-time processed transfer function;
extracting key electrical features from the processed data stream, including the voltage, the current, the temperature, and the capacity, and performing weighting in conjunction with a feature weight, and
generating a data stream feature set by using the following formula:

$$Ft = \frac{1}{Z} ( {\sum }_{k ∈ \{ V , I , T , C \}} h ( k , St ) \cdot {β}_{k} )$$

in the formula, h is a feature extraction function, βₖ is the feature weight, Z is a normalization constant, Ft denotes the data stream feature set, and V, I, T, C are respectively the voltage, the current, the temperature, and the capacity; and
performing time sequence analysis on the data stream feature set, by means of an analytic function in conjunction with a time factor, generating an analysis result of state time series by using the following formula:

$$At = m ( Ft ) \cdot {( \frac{t}{τ + t} )}^{δ}$$

in the formula, t denotes a time variable, τ is a decay constant, δ is a time-dependent intensity factor, At denotes the analysis result of state time series, Ft denotes the data stream feature set, and m denotes the time sequence analytic function.

A processed data stream formula:

$$St = g ( Qa ) \cdot ( α + \frac{{α}_{0}}{1 + {e}^{- k \cdot len ( Q a )}} ) .$$

g(Qa) denotes a real-time processing transfer function applied to the inputted queue data stream Qa;
α: a baseline adjustment factor, configured to control a basic rate of processing;
α₀: a dynamic adjustment parameter, configured to adjust a change of response with the data stream length;
k: a coefficient to adjust sensitivity, which affects the application intensity of α₀;
len(Qa): a length of Qa, i.e., the quantity of data items in the data stream;
it is assumed that len(Qa)=100 items of data, g(Qa)=200 (denotes the processed data base value), α=1.5, α₀=0.5, k=0.1;
e^{-k·len (Qa)}=e^{-0.1·100}=e⁻¹⁰≈0.000045 is calculated;
an adjustment item

$$\frac{0.5}{1 + 0.000045} \approx 0.4999775$$

is calculated;
a total adjustment factor

$$α + \frac{{α}_{0}}{1 + {e}^{- k \cdot len ( Qa )}} = 1.5 + 0.4999775 \approx 2.0$$

is calculated
a final result St=200·2.0=400 is calculated;
the finally processed data stream St=400 indicates that the adjusted processing intensity is two times that of a certain value, indicating that the processing engine has strong responsiveness to a large data flow.

A data stream feature set formula:

$$Ft = \frac{1}{Z} ( {\sum }_{k ∈ \{ V , I , T , C \}} h ( k , St ) \cdot {β}_{k} )$$

h(k, St): a feature extraction function, for data items k (voltage V, current I, temperature T, and capacity C) in St;
βₖ: a weight of each feature;
Z: a normalization constant, ensuring that the weights are reasonably distributed;
it is assumed: h(V, St)=50, h(I, St)=60, h(T, St)=40, h(C, St)=70, β_{V}=0.2, β_{I}=0.3, β_{T}=0.1, β_{C}=0.4, Z=2;
the sum of weighted features is calculated as follows:

$${\sum }_{k ∈ \{ V , I , T , C \}} h ( k , St ) \cdot {β}_{k} = 50 \times 0.2 + 60 \times 0.3 + 40 \times 0.1 + 70 \times 0.4 = 10 + 18 + 4 + 28 = 60$$

Ft is calculated as follows:

$$Ft = \frac{1}{2} \times 60 = 30 .$$

The final feature set Ft=30 denotes a weighted and normalized result after comprehensively considering all features, for subsequent time series analysis.

A formula of the analysis results of state time series:

$$At = m ( Ft ) \cdot {( \frac{t}{τ + t} )}^{δ}$$

m(Ft): a time sequence analytic function for processing Ft;
t: a current time point;
τ: a time decay constant;
δ: a time-dependent intensity factor;
it is assumed that m(Ft)=3×Ft=90 (it is assumed that the base value of the time sequence analysis is three times of Ft), t=5, τ=10, 8=2;
a time factor is calculated as follows:

$${( \frac{t}{τ + t} )}^{δ} = {( \frac{5}{10 + 5} )}^{2} = {( \frac{5}{15} )}^{2} = {( \frac{1}{3} )}^{2} = \frac{1}{9} ;$$

a final result At is calculated as follows:

$$At = 90 \times \frac{1}{9} = 10 .$$

The final analysis result of state time series At=10 denotes that under the influence of a given time point, an analysis result indicates weakening of feature influence, reflecting a significant influence of the time factor on the result.

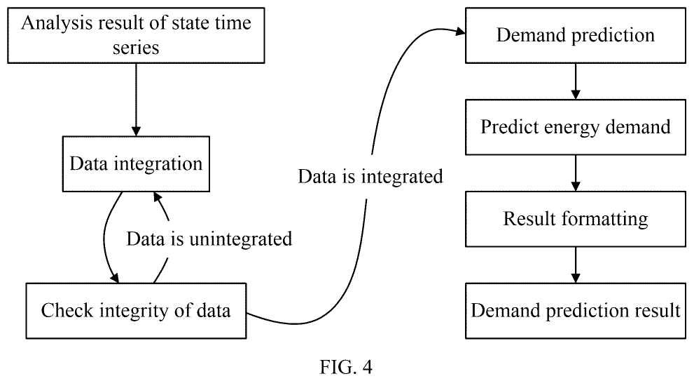

Referring to FIG. 4, the step of acquiring the prediction result specifically includes:
integrating energy data of each unit in the analysis result of state time series, combining historical data with current data by means of an enhanced integration function, and
generating integrated data by using the following formula:

$$Bo = f ( At ) \times {( {\sum }_{i = 1}^{n} \frac{{D}_{i}}{\sqrt{n}} )}^{2}$$

in the formula, Dᵢ denotes a historical energy demand of the i^{th} unit, n denotes the total number of the units, At denotes the analysis result of state time series, f denotes the enhanced integration function, and Bo denotes the integrated data;
applying a prediction model to the integrated data to dynamically calculate a demand in a future time period, and generating a predicted energy demand by using the following formula:

$$Po = p ( Bo ) \cdot {( \frac{t}{τ + t} )}^{1 / τ}$$

in the formula, τ is a time delay constant, t is a time interval from a time when data is integrated to a predicted time, Po denotes the predicted energy demand, Bo denotes the integrated data, and p denotes the demand prediction model; and
outputting the predicted energy demand in a formatted manner, matching the predicted energy demand to an energy unit management configuration, and
generating a demand prediction result by using the following formula Do=format(Po)×σ², in the formula, format is a formatting function, σ is a formatting parameter, Do denotes a demand prediction result, and Po denotes the predicted energy demand.

An integrated data stream formula:

$$Bo = f ( At ) \times {( {\sum }_{i = 1}^{n} \frac{{D}_{i}}{\sqrt{n}} )}^{2}$$

At: an analysis result of state time series, where it is assumed that the analysis result of state time series is 1000, representing an energy state indicator at a certain time point;
f(At): an integration function, which may be assumed as f(At)=At×0.1, indicating scaling of the state time sequence result to facilitate combination with historical data;
Dᵢ: a historical energy demand of the i^{th} unit, where it is assumed that the energy demand of three units is D₁=500, D₂=300, D₃=400;
n: the total number of the units, which is 3 here;
f(At): is calculated as follows:
f(At)=1000×0.1=100,
the square of the average energy demand is calculated as follows:

$${\sum }_{i = 1}^{n} \frac{{D}_{i}}{\sqrt{n}} = ( \frac{500 + 300 + 400}{\sqrt{3}} ) = \frac{1200}{\sqrt{3}} \approx 692 \text{.82}$$

$${( {\sum }_{i = 1}^{n} \frac{{D}_{i}}{\sqrt{n}} )}^{2} = 692.8 {2}^{2} \approx 480000 .$$

The finally integrated data Bo:

$$Bo = 100 \times 480000 = 48000000 .$$

This integrated data denotes a comprehensive energy demand prediction indicator after considering the historical energy demand and the current state.

An energy prediction demand formula:

$$Po = p ( Bo ) \cdot {( \frac{t}{τ + t} )}^{1 / τ}$$

p(Bo): a demand prediction model function, which is assumed as p(Bo)=Bo×0.05, indicating that the integrated data is converted into a specific energy demand prediction;
τ: a time decay constant, which is assumed as 5;
t: a time interval, from a time when the data is integrated to a predicted time, which is assumed as 10 h;
p(Bo) is calculated as follows:

$$p ( Bo ) = 48000000 \times 0.05 = 24000 \; 00 ,$$

$${( \frac{t}{τ + t} )}^{1 / τ} = {( \frac{10}{5 + 10} )}^{1 / 5} \approx 0.896 .$$

A final prediction demand Po:

$$Po = 2400000 \times 0.896 \approx 2150400.0$$

This prediction demand denotes a prediction energy demand taking the time decay into consideration.

A demand prediction result formula:

$$Do = format ( Po ) \times {σ}^{2}$$

format(Po): a formatting function, which is assumed to be simplified to format(Po)=Po, without format change;
σ: a formatting parameter, which affects the output format and is assumed as 10;
a formatted prediction demand:

$$format ( Po ) = 2150400.0$$

A final output is calculated as follows:

$$Do = 2150400 \times {10}^{2} = 2.1504 \times {10}^{7}$$

This result denotes the formatted energy demand prediction, ready to be used to report to the management system.

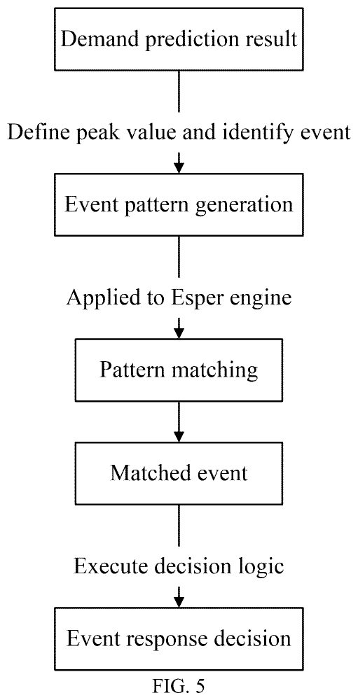

Referring to FIG. 5, the step of acquiring the event response decision specifically includes:
defining the energy demand peak and identifying the emergent bulk power consumption event by using the demand prediction result, and by applying a threshold identification method, generating an event pattern by using the following formula:

$$Eq = \{ x ∈ Do \vert x > θ \cdot ( 1 + \frac{1}{log ( e + n )} ) \}$$

in the formula, θ is a dynamically adjusted demand peak threshold, n denotes the quantity of data points in a time sequence, Eq denotes the event pattern, Do denotes the demand prediction result, and x denotes energy demand data of a single data point;
applying the event pattern to the Esper engine for pattern matching to identify a key energy event, and generating a matched event by using the following formula:

$$Mq = match ( Eq ) \times ( \frac{{\sum }_{i = 1}^{n} {ω}_{i}}{Ω} )$$

in the formula, ωᵢ is an importance weight of each event, Ω is the sum of the event weights, Mq denotes the matched event, Eq denotes the event pattern, and match denotes a pattern match function of the Esper engine; and
executing a decision logic and responding to the identified event according to the matched event to generate an event response decision by using the following formula:

$$Wq = decision ( Mq ) \times ( \frac{1}{1 + {e}^{- k \cdot m}} )$$

in the formula, k is the adjustment coefficient, m denotes the quantity of the matched events, Wq denotes the event response decision, Mq denotes the matched event, and decision denotes a decision function applied to the matched event.

An event pattern formula:

$$Eq = \{ x ∈ Do \vert x > θ \cdot ( 1 + \frac{1}{log ( e + n )} ) \}$$

Do: energy demand prediction data in every 10 minute in a hour, with a unit of megawatt (MW), Do=[10, 15, 20, 25, 30, 35];
θ: a set demand peak threshold is 20 MW;
n: the quantity of the data points is 6 (i.e., six ten-minute intervals in 1 h);
a dynamic threshold adjustment factor is calculated as follows:

$$1 + \frac{1}{log ( e + 6 )} \approx 1 + \frac{1}{log ( 8.71828 )} \approx 1 + 0.1303 \approx 1.1303 ;$$

then a new threshold is calculated as follows: θ′=20×1.1303≈22.606;
energy demands meeting conditions are screened according to the new threshold:

$$Eq = \{ x ∈ [ 10 , 15 , 20 , 25 , 30 , 35 ] \vert x > 22.606 \} = \{ 25 , 30 , 35 \} ;$$

a result Eq denotes that during observation, the energy demands at three time points exceed the adjusted peak threshold, which affects the stability and operation of the energy system.

An event pattern formula:

$$Mq = match ( Eq ) \times ( \frac{{\sum }_{i = 1}^{n} {ω}_{i}}{Ω} ) .$$

It is assumed that match (Eq) simply returns the quantity of matched events, which is 3 here (three events with the energy demands exceeding the threshold);
ωᵢ: a weight of each event is assumed as 1;
Ω=n=6 (the sum of weights of all events);
a weight ratio is calculated as follows:

$$\frac{{\sum }_{i = 1}^{3} {ω}_{i}}{Ω} = \frac{3}{6} = 0.5 .$$

A final result is calculated as follows:

$$Mq = 3 \times 0.5 = 1.5 .$$

A result Mq=1.5 denotes that after weight adjustment, the system identifies a key event with 1.5 average influence units, which is beneficial for a system decision maker to further analyze and respond.

An event response decision formula:

$$Wq = decision ( Mq ) \times ( \frac{1}{1 + {e}^{- k \cdot m}} ) .$$

It is assumed that decision (Mq) returns a basic weight of an event decision, and the basic weight is 2 here (it is assumed that two strategies need to be copied with);
k=0.5, m=1.5 (a matched event obtained from the previous step);
An exponential response is calculated as follows:

$$\frac{1}{1 + {e}^{- k \cdot m}} = \frac{1}{1 + {e}^{- 0.5 \times 1.5}} = \frac{1}{1 + {e}^{- 0.75}} \approx \frac{1}{1 + 0.4724} \approx 0.679 ;$$

a final result is calculated as follows:

$$Wq = 2 \times 0.679 \approx 1.358 .$$

A result Wq≈1.358 denotes that a strategy response intensity with about 1.358 units is needed after adjustment to process the identified event according to a decision weight of the system in the current state.

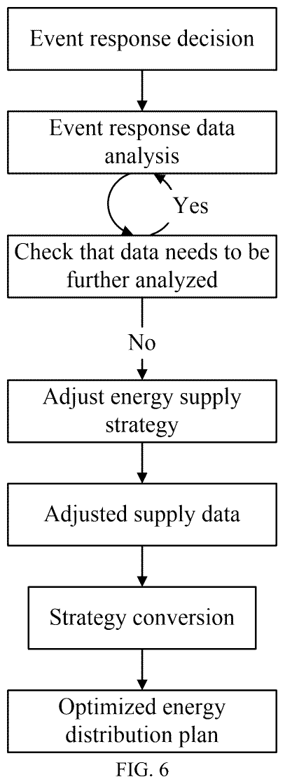

Referring to FIG. 6, the step of acquiring the optimized energy distribution plan specifically includes:
extracting data from the event response decision, analyzing and identifying the energy supply strategy needed to be adjusted, and
generating analyzed energy data by using the following formula:

$$Ar = ( {\sum }_{i = 1}^{n} {Wq}_{i} \cdot {α}_{i} ) \div {n}^{1.5}$$

in the formula, Wqᵢ denotes data of the i^{th} event response decision, αᵢ denotes the adjustment coefficient, and Ar denotes the analyzed energy data;
adjusting the energy supply strategy according to the analyzed energy data, and matching the current energy demand with the predicted energy demand, and
generating adjusted supply data by using the following formula:

$$Vr = m ( Ar ) \cdot sin ( \frac{π \cdot Ar}{max ( A r )} )$$

in the formula, m is a function that adjusts the energy supply, Vr denotes the adjusted supply data, max(Ar) denotes the maximum value in the analyzed data, and Ar denotes the analyzed energy data; and converting the adjusted supply data into an operation strategy, and
forming the optimized energy distribution plan by using the following formula:

$$Hr = strategize ( Vr ) \cdot ( 1 + \frac{log ( 1 + Vr )}{log ( 2 )} )$$

in the formula, strategize is a function that adjusts and converts the supply into a strategy, Hr denotes the optimized energy distribution plan, Vr denotes the adjusted supply data, log(1+Vr) denotes a logarithmic transformation of small value adjustment, and log(2) denotes a base of logarithm.

An analyzed energy data formula:

$$Ar = ( {\sum }_{i = 1}^{n} {Wq}_{i} \cdot {α}_{i} ) \div {n}^{1.5}$$

Wqᵢ: a value of the i^{th} decision data point, which is assumed as an emergency level score of response;
αᵢ: an adjustment coefficient of the i^{th} data point, reflecting the relative importance of the data point;
n: the total number of the data points, indicating the number of decision points taken into consideration;
it is assumed that 3 decision data points exist, i.e., n=3, the decision data points Wq are respectively 10, 15, and 20, and the adjustment coefficients α are respectively 1.2, 0.8, and 1.0;
a weighted value of each decision point is calculated as follows:

$${Wq}_{1} \cdot {α}_{1} = 10 \times 1.2 = 12 ,$$

$${Wq}_{2} \cdot {α}_{2} = 15 \times 0.8 = 12 ,$$

$${Wq}_{3} \cdot {α}_{4} = 20 \times 1.0 = 20 ;$$

all weighted values are summated:

$${\sum }_{i = 1}^{n} {Wq}_{i} \cdot {α}_{i} = 12 + 12 + 20 = 44$$

divided by n^{1.5}:

$${n}^{1.5} = {3}^{1.5} = 5.196 .$$

Ar is calculated as follows:

$$Ar = \frac{44}{5.196} \approx 8.47 .$$

The obtained Ar≈8.47 denotes the weighted average decision emergency level.

An adjusted supply data formula:

$$Vr = m ( Ar ) \cdot sin ( \frac{π \cdot Ar}{max ( A r )} )$$

m(Ar): an energy adjustment function, which is assumed as m(x)=2x;
Ar: analyzed energy data:
max(Ar): the maximum value of Ar, which is assumed as 10;
Ar≈8.47 (calculated from the previous step) is used;
m(Ar) is calculated as follows:

$$m ( Ar ) = m ( 8.47 ) = 2 \times 8.47 = 16.94 .$$

A sinusoidal part is calculated as follows:

$$sin ( \frac{π \cdot Ar}{max ( Ar )} ) = sin ( \frac{π \cdot 8.47}{10} ) = sin ( 2.654 ) \approx 0.445 .$$

A final result:

$$Vr = 16.94 \times 0.445 \approx 7.54 .$$

The obtained Vr≈7.54 denotes the adjusted energy supply index.

An optimized energy distribution plan formula:

$$Hr = strategize ( Vr ) \times ( 1 + \frac{log ( 1 + Vr )}{log ( 2 )} )$$

strategize(Vr): a function that converts energy supply into a specific strategy, which is assumed as strategize(Vr)=x²;
Vr: the adjusted supply data;
log(2): a base of Natural Logarithm 2, which is approximately equal to 0.693;
Vr≈7.54 (calculated from the previous step) is used:
a strategy conversion function is calculated as follows:

$$strategize ( Vr ) = strategize ( 7.54 ) = {( 7.54 )}^{2} = 56.8 \; 516 ;$$

a logarithmic part is calculated as follows:

$$\frac{log ( 1 + Vr )}{log ( 2 )} = \frac{log ( 1 + 7.54 )}{log ( 2 )} = \frac{log ( 8.54 )}{0.693} \approx 3.41 .$$

A final result:

$$Hr = 56.8516 \times ( 1 + 3.41 ) \approx 294.44$$

The obtained Hr≈249.44 denotes a comprehensive effect index of the finally formed adjustment strategy.

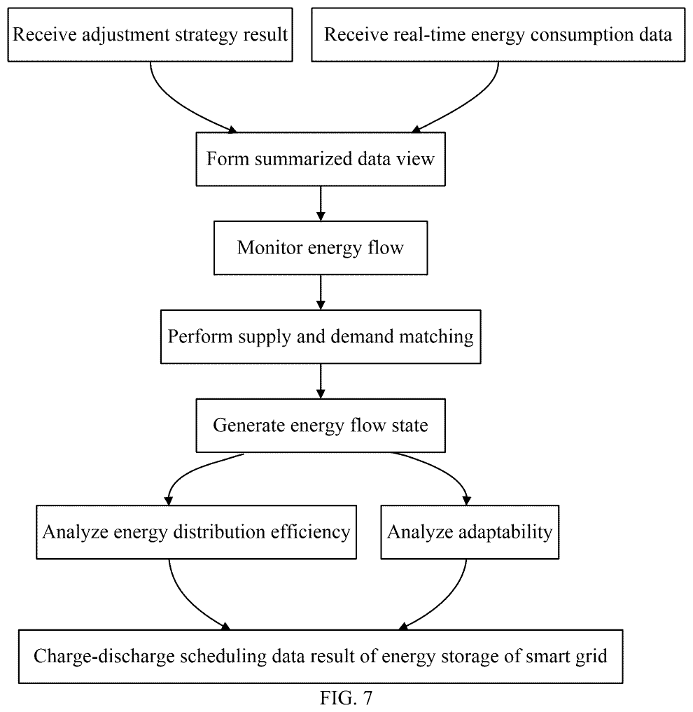

Referring to FIG. 7, the step of acquiring the charge-discharge scheduling data result of energy storage of the smart grid specifically includes:
receiving the optimized energy distribution plan, and forming a summarized data view in conjunction with real-time energy consumption data by using the following formula:

$$Iu = \frac{{\sum }_{i = 1}^{n} ( {Hr}_{i} \times {C}_{i} )}{\sqrt{n}}$$

in the formula, Iu denotes the summarized data, Hrᵢ denotes the i^{th} strategy result data point, Cᵢ denotes corresponding energy consumption data, and n is the quantity of the data points;
monitoring energy flow by means of the summarized data view, and matching the supply with the demand, adjusting energy charge and discharge, and
generating an energy flow state by using the following formula:

$$Fu = {( {{\sum }_{i = 1}}^{n} {Iu}_{i} \times {λ}_{i} )}^{\frac{1}{v}}$$

in the formula, λᵢ is a weight factor of each data point, v is a global parameter that adjusts a nonlinear response, Fu denotes the energy flow state, and Iu denotes the summarized data; and
analyzing an efficiency and adaptability of energy distribution according to the energy flow state, and generating the charge-discharge scheduling data result of energy storage of the smart grid by using the following formula:

$$Eu = ( \frac{{\sum }_{i = 1}^{n} {Fu}_{i}}{{μ}_{i}} ) \cdot κ$$

in the formula, μᵢ is an efficiency benchmark of each state, κ is a coefficient for adaptive analysis, Eu denotes the charge-discharge scheduling data result of energy storage of the smart grid, and Fu denotes the energy flow state.

A summarized data formula:

$$Iu = \frac{{\sum }_{i = 1}^{n} ( {Hr}_{i} \times {C}_{i} )}{\sqrt{n}}$$

Hrᵢ denotes a data point of the i^{th} optimized energy distribution plan, assuming that the data is from calculation of the previous step or a real-time system feedback;
Cᵢ denotes the i^{th} energy consumption data point according to the feedback of monitoring the system in real time;
n denotes the total number of the data points for standardized data processing;
it is assumed that 3 strategy result data points exist: Hr=[2, 3, 5], the corresponding energy consumption data is C=[100, 150, 200], so n=3;
Iu is calculated as follows:

$$Iu = \frac{2 \times 100 + 3 \times 150 + 5 \times 200}{\sqrt{3}} = \frac{200 + 450 + 1000}{1.732} \approx \frac{1650}{1.732} \approx 952.81 .$$

This result (952.81) denotes the integrated data index under a circumstance that the strategy adjustment and the energy consumption data are given.

An energy flow state formula:

$$Fu = {( {{\sum }_{i = 1}}^{n} {Iu}_{i} \times {λ}_{i} )}^{\frac{1}{v}}$$

Iu: an integrated data point obtained from the first step;
λᵢ: a weight factor of each data point, which is assumed as a standard weight acquired from the historical data or an expert system here;
v: a global parameter, configured to adjust nonlinear response;
Iu=952.81 in the previous example is continuously used, assuming λᵢ=[1, 1.5, 2], v=2;
Fu is calculated as follows:

$$Fu = {( 952.81 \times 1 + 952.81 \times 1.5 + 952.81 \times 2 )}^{\frac{1}{2}} = {( 952.81 \times 4.5 )}^{\frac{1}{2}} \approx 65.48 .$$

This result (65.48) denotes an adjustment state index of an energy flow.

A charge-discharge scheduling data result formula of energy storage of a smart grid:

$$Eu = ( \frac{{\sum }_{i = 1}^{n} {Fu}_{i}}{{μ}_{i}} ) \cdot κ$$

Fu: an energy flow state data point obtained from the previous step;
μᵢ: an efficiency benchmark of each state, assuming that it is estimated according to an industrial standard or previous performance;
κ: a global adaptability coefficient, which enhances the depth of the system adaptability analysis;

$$Fu = 65.48 is used , assuming {μ}_{i} = [ 1 , 1 , 1 ] , κ = 1.1 ;$$

Eu is calculated as follows:

$$Eu = ( \frac{65.48 + 65.48 + 65.48}{1 + 1 + 1} ) \cdot 1.1 = ( 65.48 ) \cdot 1.1 = 72.028 .$$

This result (72.028) denotes a comprehensive estimation index of the energy distribution efficiency and the system adaptability.

A grid-forming energy storage control method executed through the grid-forming energy storage system includes the following steps:
S1: collecting the data of voltage, current, temperature, and remaining capacity of the energy storage unit through a control interface, formatting the data into JSON and controlling a data transmission process through the TCP/IP protocol, and optimizing a size and a transmission frequency of a data packet and matching a network condition to generate an encoded data stream;
S2: transmitting the data to Apache Kafka for control processing by means of the encoded data stream, and optimizing reliability of message processing by controlling sequencing and error detection of the data stream in the message queue to obtain a queue data stream;
S3: performing data control analysis on the queue data stream in a Spark Streaming environment, continuously monitoring the voltage, the current, the temperature, and the capacity, analyzing a time series variation of parameters, and controlling and identifying an abnormal pattern to generate the analysis result of state time series;
S4: controlling a calculation of demand prediction according to the analysis result of state time series, defining and identifying the energy peak value and the emergent bulk power consumption event, controlling real-time response processing of the event, and adjusting an output configuration of the energy storage unit to acquire an event response decision; and
S5: controlling energy supply and output of energy storage by using the event response decision, adjusting the charge-discharge strategy according to a demand, controlling an energy flow and consumption condition of a network, and analyzing and adjusting the energy distribution strategy and optimizing energy storage control configuration performance to establish the charge-discharge scheduling data result of energy storage of the smart grid.

The above is merely preferred embodiments of the present disclosure, rather than limiting the present disclosure in other forms. Those skilled in the art may alter or modify the technical content disclosed above into equivalent embodiments of equivalent variations and apply them to other fields. However, any simply amendment, equivalent change and modification made on the above embodiments according to the technical essence of the present disclosure without departing from the content of the technical solution of the present disclosure still fall within the protection scope of the technical solution of the present disclosure.

What is claimed is:

1. A grid-forming energy storage system, comprising:
a data interface and transfer module, configured to perform JSON formatting on key parameters of a voltage, a current, a temperature, and a remaining capacity of an energy storage unit, according to data of an energy storage unit, wherein the data is transmitted to a central control configuration through a TCP/IP protocol to obtain an encoded data stream, and the encoded data stream is inputted to an Apache Kafka message queue to acquire a queue data stream;
a state analysis and prediction module, configured to input the queue data stream to a real-time data processing engine based on Spark Streaming to analyze data of the voltage, the current, the temperature, and the capacity, so as to obtain an analysis result of state time series, and dynamically estimate an energy demand of each unit to acquire a demand prediction result according to the analysis result of state time series;
an event response and strategy adjustment module, configured to identify an energy demand peak and an emergent bulk power consumption event according to the demand prediction result, match an event pattern, execute event processing by using an Esper engine to obtain an event response strategy, and adjust energy supply by means of the event response decision to acquire an optimized energy distribution plan; and
an energy scheduling and management module, configured to receive the optimized energy distribution plan, adjust a charge-discharge strategy according to demand, record an energy flow condition, and analyze a charge-discharge efficiency of energy storage and adaptability to obtain a charge-discharge scheduling data result of energy storage of the smart grid.

2. The grid-forming energy storage system according to claim 1, wherein the step of acquiring the queue data stream comprises:
based on the data of the energy storage unit, converting each key parameter value of the energy storage unit into an attribute of a JSON object through a formatting function, generating a formatted data packet by using the following formula:
$$Ja = {\sum }_{k ∈ K} f ( {p}_{k} ) \times {w}_{k} \div N$$
in the formula, K denotes the key parameter, pₖ denotes a real-time numerical value of a parameter k, f denotes a data formatting function, wₖ denotes a weight of the parameter k, N denotes the total number of parameters, and Ja denotes the formatted data packet;
by means of a transmitting function, transmitting the formatted data packet through the TCP/IP protocol, generating an encoded data stream by using the following formula:
$$Ea = \frac{1}{\sqrt{n}} {{\sum }_{i = 1}}^{n} s ( {Ja}_{i} )$$
in the formula, Jaᵢ denotes the i^{th} formatted data packet, n denotes the quantity of the data packets, s denotes the transmitting function, and Ea denotes the encoded data stream; and
inputting the encoded data stream to the Apache Kafka message queue, and by means of a queue function, generating a queue data stream by using the following formula:
$$Qa = q ( Ea ) \times ( 1 + \frac{1}{L} )$$
in the formula, Ea denotes the encoded data stream, q denotes the queue function, L denotes a load factor, and Qa denotes the queue data stream.

3. The grid-forming energy storage system according to claim 2, wherein the step of acquiring the analysis result of state time series comprises:
performing real-time processing on the queue data stream through a Spark Streaming engine, adjusting a processing speed and responsiveness of the data stream by applying a transfer function and combining an adjustment parameter, and
generating a processed data stream by using the following formula:
$$St = g ( Qa ) \cdot ( α + \frac{{α}_{0}}{1 + {e}^{- k \cdot len ( Qa )}} )$$
in the formula, α is a baseline adjustment factor, α₀ and k are dynamic adjustment parameters, len(Qa) is configured to calculate a queue length, St denotes the processed data stream, Qa denotes an inputted queue data stream, and g is a real-time processed transfer function;
extracting key electrical features from the processed data stream, comprising the voltage, current, temperature, and capacity, and performing weighting in conjunction with a feature weight, and
generating a data stream feature set by using the following formula:
$$Ft = \frac{1}{Z} ( {\sum }_{k ∈ \{ V , I , T , C \}} h ( k , St ) \cdot {β}_{k} )$$
in the formula, h is a feature extraction function, βₖ is the feature weight, Z is a normalization constant, Ft denotes the data stream feature set, and V, I, T, C are respectively the voltage, the current, the temperature, and the capacity; and
performing time series analysis on the data stream feature set, by means of an analytic function in conjunction with a time factor, generating an analysis result of state time series by using the following formula:
$$At = m ( Ft ) \cdot {( \frac{t}{τ + t} )}^{δ}$$
in the formula, t denotes a time variable, τ is a decay constant, δ is a time-dependent intensity factor, At denotes the analysis result of state time series, Ft denotes the data stream feature set, and m denotes the time series analytic function.

4. The grid-forming energy storage system according to claim 3, wherein the step of acquiring the demand prediction result specifically comprises:
integrating energy data of each unit in the analysis result of state time series, combining historical data with current data by means of an enhanced integration function, and generating integrated data by using the following formula:
$$Bo = f ( At ) \times {( {{\sum }_{i = 1}}^{n} \frac{{D}_{i}}{\sqrt{n}} )}^{2}$$
in the formula, Dᵢ denotes a historical energy demand of the i^{th} unit, n denotes the total number of the units, At denotes the analysis result of state time series, f denotes the enhanced integration function, and Bo denotes the integrated data;
applying a prediction model to the integrated data to dynamically calculate a demand in a future time period, and generating a predicted energy demand by using the following formula:
$$Po = p ( Bo ) \cdot {( \frac{t}{τ + t} )}^{1 / τ}$$
in the formula, τ is a time delay constant, tis a time interval from a time when data is integrated to a predicted time, Po denotes the predicted energy demand, Bo denotes the integrated data, and p denotes the demand prediction model; and
outputting the predicted energy demand in a formatted manner, matching the predicted energy demand to an energy unit management configuration, and generating a demand prediction result by using the following formula:
$$Do = format ( Po ) \times {σ}^{2}$$
in the formula, format is a formatting function, σ is a formatting parameter, Do denotes a demand prediction result, and Po denotes the predicted energy demand.

5. The grid-forming energy storage system according to claim 4, wherein the step of acquiring the event response decision specifically comprises:
defining the energy demand peak and identifying the emergent bulk power consumption event by using the demand prediction result, and by applying a threshold identification method, generating an event pattern by using the following formula:
$$Eq = \{ x ∈ Do \vert x > θ \cdot ( 1 + \frac{1}{log ( e + n )} ) \}$$
in the formula, θ is a dynamically adjusted demand peak threshold, n denotes the quantity of data points in a time series, Eq denotes the event pattern, Do denotes the demand prediction result, and x denotes energy demand data of a single data point;
applying the event pattern to the Esper engine for pattern matching to identify a key energy event, and generating a matched event by using the following formula:
$$Mq = match ( Eq ) \times ( \frac{{\sum }_{i = 1}^{n} {ω}_{i}}{Ω} )$$
in the formula, ωᵢ is an importance weight of each event, Ω is the sum of the event weights, Mq denotes the matched event, Eq denotes the event pattern, and match denotes a pattern match function of the Esper engine; and
based on the matched event, executing a decision logic and responding to the identified event, generating an event response decision by using the following formula:
$$Wq = decision ( Mq ) \times ( \frac{1}{1 + {e}^{- k \cdot m}} )$$
in the formula, k is the adjustment coefficient, m denotes the quantity of the matched events, Wq denotes the event response decision, Mq denotes the matched event, and decision denotes a decision function applied to the matched event.

6. The grid-forming energy storage system according to claim 5, wherein the step of acquiring the optimized energy distribution plan specifically comprises:
extracting data from the event response decision, analyzing and identifying the energy supply strategy needed to be adjusted, and generating analyzed energy data by using the following formula:
$$Ar = ( {{\sum }_{i = 1}}^{n} {Wq}_{i} \cdot {α}_{i} ) \div {n}^{1.5}$$
in the formula, Wqᵢ denotes data of the i^{th} event response decision, αᵢ denotes the adjustment coefficient, and Ar denotes the analyzed energy data;
adjusting the energy supply strategy according to the analyzed energy data, and matching the current energy demand with the predicted energy demand, and generating adjusted supply data by using the following formula:
$$Vr = m ( Ar ) \cdot sin ( \frac{π \cdot Ar}{max ( Ar )} )$$
in the formula, m is a function that adjusts the energy supply, Vr denotes the adjusted supply data, max(Ar) denotes the maximum value in the analyzed data, and Ar denotes the analyzed energy data; and
converting the adjusted supply data into an operation strategy, and forming the optimized energy distribution plan by using the following formula:
$$Hr = strategize ( Vr ) \cdot ( 1 + \frac{log ( 1 + Vr )}{log ( 2 )} )$$
in the formula, strategize is a function that adjusts and converts the supply into a strategy, Hr denotes the optimized energy distribution plan, Vr denotes the adjusted supply data, log(1+Vr) denotes a logarithmic transformation of small value adjustment, and log(2) denotes a base of logarithm.

7. The grid-forming energy storage system according to claim 6, wherein the step of acquiring the charge-discharge scheduling data result of energy storage of the smart grid specifically comprises:
receiving the optimized energy distribution plan, and forming a summarized data view in conjunction with real-time energy consumption data by using the following formula:
$$Iu = \frac{{\sum }_{i = 1}^{n} ( {Hr}_{i} \times {C}_{i} )}{\sqrt{n}}$$
in the formula, Iu denotes the summarized data, Hrᵢ denotes the i^{th} strategy result data point, Cᵢ denotes corresponding energy consumption data, and n is the quantity of the data points;
monitoring energy flow by means of the summarized data view, and matching the supply with the demand, adjusting energy charge and discharge, and generating an energy flow state by using the following formula:
$$Fu = {( {{\sum }_{i = 1}}^{n} {Iu}_{i} \times {λ}_{i} )}^{\frac{1}{v}}$$
in the formula, λᵢ is a weight factor of each data point, v is a global parameter that adjusts a nonlinear response, Fu denotes the energy flow state, and Iu denotes the summarized data; and
based on the energy flow state, analyzing an efficiency and adaptability of energy distribution, and generating the charge-discharge scheduling data result of energy storage of the smart grid by using the following formula:
$$Eu = ( \frac{{\sum }_{i = 1}^{n} {Fu}_{i}}{{μ}_{i}} ) \cdot κ$$
in the formula, μᵢ is an efficiency benchmark of each state, κ is a coefficient for adaptive analysis, Eu denotes the charge-discharge scheduling data result of energy storage of the smart grid, and Fu denotes the energy flow state.

8. A grid-forming energy storage control method, executed through the grid-forming energy storage system according to claim 1, comprising the following steps:
collecting the data of voltage, current, temperature, and remaining capacity of the energy storage unit through a control interface, formatting the data into JSON and controlling a data transmission process through the TCP/IP protocol, and optimizing a size and a transmission frequency of a data packet and matching a network condition to generate an encoded data stream;
transmitting the data to Apache Kafka for control processing by means of the encoded data stream, and optimizing reliability of message processing by controlling sequencing and error detection of the data stream in the message queue to obtain a queue data stream;
performing data control analysis on the queue data stream in a Spark Streaming environment, continuously monitoring the voltage, current, temperature, and capacity, analyzing a time series variation of parameters, and controlling and identifying an abnormal pattern to generate the analysis result of state time series;
based on the analysis result of state time series, controlling a calculation of demand prediction, defining and identifying the energy peak value and the emergent bulk power consumption event, controlling real-time response processing of the event, and adjusting an output configuration of the energy storage unit to acquire an event response decision; and
controlling energy supply and output of energy storage by using the event response decision, adjusting the charge-discharge strategy according to a demand, controlling an energy flow and consumption condition of a network, and analyzing and adjusting the energy distribution strategy and optimizing energy storage control configuration performance to establish the charge-discharge scheduling data result of energy storage of the smart grid.
